(19) United States
(12) Patent Application Publication
(10) Pub. No.: US 2018/0131640 A1
(43) Pub. Date: May 10, 2018

(54) TECHNIQUES FOR ENCODING AND DECODING MULTIPLE ACKNOWLEDGEMENT SIGNALS IN NEW RADIO

(71) Applicant: QUALCOMM Incorporated, San Diego, CA (US)

(72) Inventors: Sitaramanjaneyulu KANAMARLAPUDI, San Diego, CA (US); Shailesh MAHESHWARI, San Diego, CA (US); Sivaramakrishna VEEREPALLI, San Diego, CA (US); Arnaud MEYLAN, San Diego, CA (US)

(21) Appl. No.: 15/495,335

(22) Filed: Apr. 24, 2017

Related U.S. Application Data
(60) Provisional application No. 62/418,634, filed on Nov. 7, 2016.

(51) Int. Cl. H04L 12/861; H04L 12/801

(52) U.S. Cl. CPC H04L 49/9057; H04W 84/042; H04L 47/34

(57) ABSTRACT

A method and apparatus for encoding and decoding multiple Acknowledgements (ACKs) during wireless communications are described. In one example, the method and apparatus include receiving multiple ACKs in a queue, the multiple ACKs being scheduled for transmission on a communication channel. The method and apparatus include generating a packet using two or more ACKs of the multiple ACKs that correspond to a first flow, wherein the packet includes Sequence Numbers (SNs) of each of the two or more ACKs, an ACK counter value indicating a number of ACKs in the packet, and a payload corresponding to contents of one of the two or more ACKs. The method and apparatus include transmitting the packet on the communication channel.

CLAIM OF PRIORITY UNDER 35 U.S.C. § 119 The present Application for Patent claims priority to U.S. Provisional Application No. 62/418,634 entitled “TECHNIQUES FOR ENCODING AND DECODING MULTIPLE ACKNOWLEDGEMENT SIGNALS IN NEW RADIO” filed Nov, 7, 2016, which is assigned to the assignee hereof and hereby expressly incorporated by reference herein.

### BACKGROUND

Aspects of this disclosure relate generally to telecommunications, and more particularly to techniques for encoding and decoding multiple Acknowledgements (ACKs) during wireless communications.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems.

These multiple access technologies have been adopted in various telecommunication standards to provide a common protocol that enables different wireless devices to communicate on a municipal, national, regional, and even global level. For example, fifth generation (5G) NR (new radio) communications technology is envisaged to expand and support diverse usage scenarios and applications with respect to current mobile network generations. In an aspect, 5G communications technology includes enhanced mobile broadband addressing human-centric use cases for access to multimedia content, services and data; URLLC with strict requirements, especially in terms of latency and reliability; and massive machine type communications for a very large number of connected devices and typically transmitting a relatively low volume of non-delay-sensitive information. However, as the demand for mobile broadband access continues to increase, there exists a need for further improvements in 5G communications technology and beyond. Preferably, these improvements should be applicable to other multi-access technologies and the telecommunication standards that employ these technologies.

Techniques are needed to provide efficient and improved process for communicating ACKs during wireless communications. In certain instances, as the next generation of wireless communications come into existence, specific latency and reliability requirements are needed to be met in order to ensure adequate levels of wireless communications. Thus, improvements in encoding and decoding multiple ACKs during wireless communication are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method includes encoding multiple ACKs during wireless communications. The described aspects include receiving multiple ACKs in a queue, the multiple ACKs being scheduled for transmission on a communication channel. The described aspects further include generating a packet using two or more ACKs of the multiple ACKs that correspond to a first flow, wherein the packet includes sequence numbers (SNs) of each of the two or more ACKs, and a payload corresponding to contents of one of the two or more ACKs. The described aspects further include transmitting the packet on the communication channel.

In an aspect, an apparatus for encoding multiple ACKs during wireless communications may include a transceiver, a memory; and at least one processor coupled to the memory and configured to receive multiple ACKs in a queue, the multiple ACKs being scheduled for transmission on a communication channel. The described aspects further generate a packet using two or more ACKs of the multiple ACKs that correspond to a first flow, wherein the packet includes SNs of each of the two or more ACKs, and a payload corresponding to contents of one of the two or more ACKs. The described aspects further transmit the packet on the communication channel.

In an aspect, a computer-readable medium may store computer executable code for encoding multiple ACKs during wireless communications is described. The described aspects include code for receiving multiple ACKs in a queue, the multiple ACKs being scheduled for transmission on a communication channel. The described aspects further include code for generating a packet using two or more ACKs of the multiple ACKs that correspond to a first flow, wherein the packet includes SNs of each of the two or more ACKs, and a payload corresponding to contents of one of the two or more ACKs. The described aspects further include code for transmitting the packet on the communication channel.

In an aspect, an apparatus for encoding multiple ACKs during wireless communications is described. The described aspects include means for receiving multiple ACKs in a queue, the multiple ACKs being scheduled for transmission on a communication channel. The described aspects further include means for generating a packet using two or more ACKs of the multiple ACKs that correspond to a first flow, wherein the packet includes SNs of each of the two or more ACKs, and a payload corresponding to contents of one of the two or more ACKs. The described aspects further include means for transmitting the packet on the communication channel.

In accordance with another aspect, a method includes decoding multiple ACKs during wireless communications. The described aspects include receiving a packet on a communication channel, the packet including SNs of each of two or more ACKs that correspond to a first flow, and a payload corresponding to contents of one of the two or more ACKs, the two or more ACKs each corresponding to two or more packets previously transmitted on the communication channel. The described aspects further include generating a number of ACKs corresponding to the first flow based on the packet using the SNs of each of the two or more ACKs, the ACK counter value, and the payload.

In an aspect, an apparatus for decoding multiple ACKs during wireless communications may include a transceiver, a memory; and at least one processor coupled to the memory and configured to receive a packet on a communication channel, the packet including SNs of each of two or more ACKs that correspond to a first flow, and a payload corresponding to contents of one of the two or more ACKs, the two or more ACKs each corresponding to two or more packets previously transmitted on the communication channel. The described aspects further generate a number of ACKs corresponding to the first flow based on the packet using the SNs of each of the two or more ACKs, the ACK counter value, and the payload.

In an aspect, a computer-readable medium may store computer executable code for decoding multiple ACKs during wireless communications is described. The described aspects include code for receiving a packet on a communication channel, the packet including SNs of each of two or more ACKs that correspond to a first flow, and a payload corresponding to contents of one of the two or more ACKs, the two or more ACKs each corresponding to two or more packets previously transmitted on the communication channel. The described aspects further include code for generating a number of ACKs corresponding to the first flow based on the packet using the SNs of each of the two or more ACKs, the ACK counter value, and the payload.

In an aspect, an apparatus for decoding multiple ACKs during wireless communications is described. The described aspects include means for receiving a packet on a communication channel, the packet including SNs of each of two or more ACKs that correspond to a first flow, and a payload corresponding to contents of one of the two or more ACKs, the two or more ACKs each corresponding to two or more packets previously transmitted on the communication channel. The described aspects further include means for generating a number of ACKs corresponding to the first flow based on the packet using the SNs of each of the two or more ACKs, the ACK counter value, and the payload.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a schematic diagram of a wireless communication network including at least one base station having a search space determination component configured to determine and transmit an aggregation level profile associated with a UE and at least one UE having a channel estimation component configured to perform channel estimation by using a binary tree based PDCCH search space

FIG. 2 is a conceptual diagram of a data packet during wireless communications in accordance with various aspects of the present disclosure.

FIG. 3 is a conceptual diagram of control packet during wireless communications in accordance with various aspects of the present disclosure.

FIG. 4 is a conceptual diagram of a header of a packet during wireless communications in accordance with various aspects of the present disclosure.

FIGS. 5 and 6 are schematic diagrams of a communication network including an aspect of an ACK formatting component during wireless communications in accordance with various aspects of the present disclosure.

FIG. 7 is a flow diagram illustrating an example method of encoding multiple ACKs during wireless communications in accordance with various aspects of the present disclosure.

FIG. 8 is a flow diagram illustrating an example method of decoding multiple ACKs during wireless communications in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to encoding and decoding multiple ACKs during wireless communications. In particular, with the increased data rates in uplink communications (10 Gbps) and downlink communications (20 Gbps) with reduced latency requirements (e.g., 4 ms for uplink and downlink), reducing the latency as well as increasing the throughput by various techniques to encode/decode and process the data packets is helpful. In an aspect, during any bi-directional communication scenarios, even though a transmitter is able to transmit data quickly over an air interface, the flow is limited based on the ACKs received from the receiver. For example, when the network is transmitting data at very high rate in the downlink with a sufficient amount of scheduling, the UE is also having data transmitted in the uplink, but due to various queues in the data pipe, the ACKs in uplink corresponding to downlink data are delayed. As such, the rate of the downlink data is slowed since the flow and window management depends on the timely reception of ACKs.

In some aspect, various techniques are already in place to improve the ACK transmission in the uplink in the current radio technologies, such as, prioritizing the ACKs in the internal queues by pushing the ACKs to the front of the queue when there is lot of data pending for transmission in the queue. However, these techniques are limited to prioritizing the ACKs over the data in the queues, but cannot achieve quick and efficient delivery of the ACKs to the network data layer when a large number of ACKs are pending to be transmitted with limited grant. For example, when the network is transmitting data in the downlink with a sufficient amount of scheduling, the UE may be transmitting data in the uplink. The UE is prioritizing the ACKs in the uplink over the data before encoding into Packet Data Convergence Protocol Packet Data Units (PDUs). During the initial stage of a connection, for every data transmitted in the downlink, there may be one ACK transmitted in the uplink. With window/buffer management, every DL TCP packet expects a TCP ACK in the UL. Later, in the steady state phase of the TCP Data, every alternate data in the downlink will generate one ACK in the uplink. As such, even though ACKs are prioritized, as the downlink rate increases (e.g., to 20 Gbps), a large number of ACKs are still used in the uplink.

In an aspect, the network has to provide large amounts of grants in the uplink to ensure an uplink data rate of 346 Mbps (IPv4) traffic or 480 Mbps (IPv6) traffic, just to support the ACK transmissions when transmitting DL peak rates of 20 Gbps. In another example, the network has to provide large amounts of grants in the uplink to ensure an uplink data rate of 86.7 Mbps (IPv4) traffic or 120 Mbps (IPv6) traffic, just to support the ACK transmissions when transmitting DL peak rates of 5 Gbps Thus, for higher DL rates, a large number of ACKs may be transmitted. Any additional transmission in the uplink is a drain on power in addition to network resource utilization. In addition, more radio resources like uplink bandwidth may be used. This problem becomes worse with any Block Error Rate (BLER), as in-sequence PDU delivery is used on the peer network side to deliver ACKs from the UE to the network stack. One missing ACK in the pipe can delay the remaining ACKs which are to be transmitted to the network. Traditionally, the stack is immune to occasional loss of ACKs, but moves the window as the ACKs arrive based on various principles like ACK Clock gating, etc. Located above the RLC layer of the user plane is the PDCP. The PDCP performs a number of functions such as i) header compression of IP packets along with their corresponding decompression, ii) integrity verification and protection which helps ensure the correct source sends the control information, and iii) ciphering and deciphering both user and control plane data. Also, the PDCP is used for sending most RRC messages. In the UL direction, PDCP SDUs are received from the RRC and NAS, ciphered, and sent to the RLC layer. In the downlink direction, the PDCP also handles in-order delivery and detects duplicate packets. Also, to ensure no data is lost in connection with a handover, non-delivered packets are forwarded to a new eNB by the PDCP layer. In the uplink direction, all packets not having been indicated by lower layers as having been completed will be retransmitted by the PDCP layer because HARQ buffers will be flushed by lower layers when a handover occurs. Currently, each PDCP PDU encodes one PDCP Service Data Unit (SDU), which can be an ACK packet. As the downlink rate increases, ACKs in the uplink increase and PDCP PDUs may increase which brings additional cost in terms of per packet processing, leading to higher Microprocessor without Interlocked Pipeline Stages (MIPS) requirement to send a large number of ACKs. Thus, more processing occurs as each TCP ACK is coded as a PDCP PDU. Furthermore, a large PDCP SN space is used in addition to a large number of ciphering/deciphering operations.

Accordingly, in some aspects, the present methods and apparatuses may provide an efficient solution, as compared to current solutions, by encoding and decoding multiple TCP/IP ACKs during wireless communications. In other words, in the present aspects, multiple ACKs may be combined and transmitted instead of transmitting ACKs separately in order to satisfy latency and reliability requirements. As such, the present aspects provide one or more mechanisms for receiving multiple ACKs in a queue, the multiple ACKs being scheduled for transmission on a communication channel. Moreover, the present aspects also provide one or more mechanisms for generating a packet using two or more ACKs of the multiple ACKs that correspond to a first flow, wherein the packet includes SNs of each of the two or more ACKs, an ACK counter value indicating a number of ACKs in the packet, and a payload corresponding to contents of one of the two or more ACKs. The payload may be encoded by including the whole first ACK, and only the difference of the subsequent ones compared to the first one. The IP header for the TCP ACK may be compressed/omitted as well. Additionally, the present aspects also provide one or more mechanisms for transmitting the packet on the communication channel. The present aspects further provide one or more mechanisms for receiving a packet on a communication channel, the packet including SNs of each of two or more ACKs that correspond to a first flow, an ACK counter value indicating a number of ACKs in the packet, and a payload corresponding to contents of one of the two or more ACKs, the two or more ACKs each corresponding to two or more packets previously transmitted on the communication channel. The present aspects further provide one or more mechanisms for generating a number of ACKs corresponding to the first flow based on the packet using the SNs of each of the two or more ACKs, the ACK counter value, and the payload.

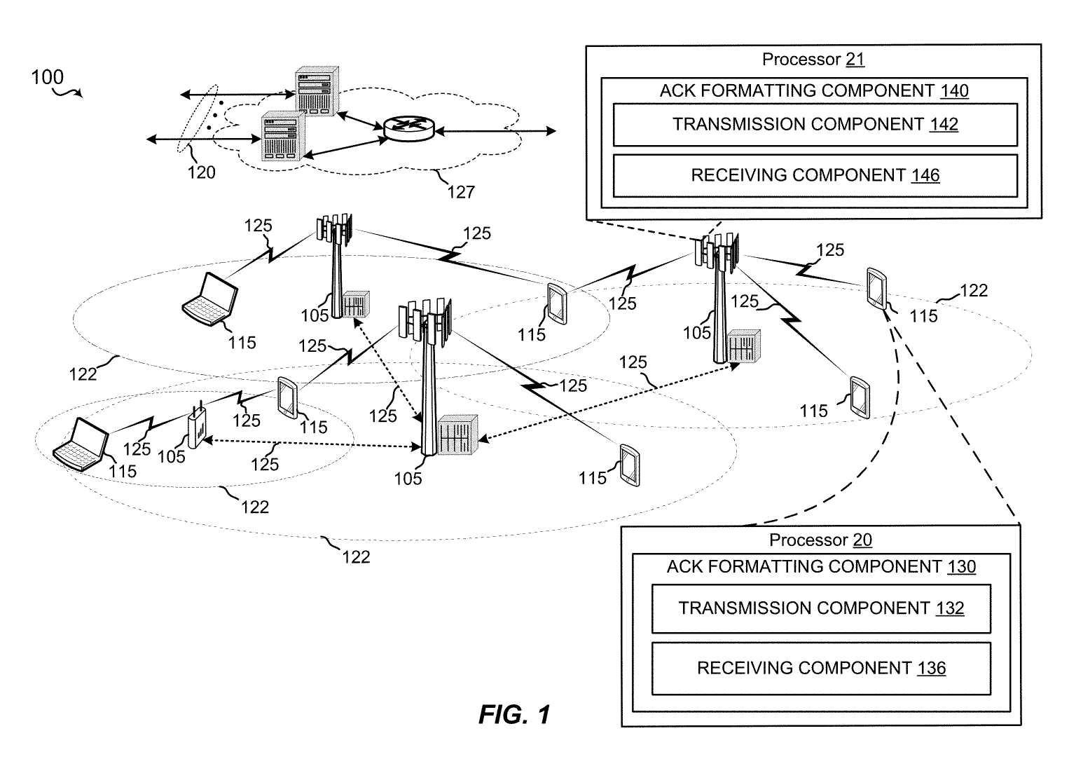

Referring to FIG. 1, in accordance with various aspects of the present disclosure, an example wireless communication network 100 includes at least one UE 115 with a processor 20 having an ACK formatting component 130 that encodes multiple ACKs in a new radio wireless communication system. Further, wireless communication network 100 includes at least one base station 105 with a processor 21 having an ACK formatting component 140 that decodes multiple ACKs during wireless communications.

In an aspect, base station 105 may execute ACK formatting component 140 to receive a packet on a communication channel (e.g., communication link 125), the packet including SNs of each of two or more ACKs that correspond to a first flow, an ACK counter value indicating a number of ACKs in the packet, and a payload corresponding to contents of one of the two or more ACKs, the two or more ACKs each corresponding to two or more packets previously transmitted on the communication channel. The base station 105 and/or ACK formatting component 140 may generate a number of ACKs corresponding to the first flow using the SNs of each of the two or more ACKs, the ACK counter value, and the payload included in the packet.

In an aspect, UE 115 may execute ACK formatting component 130 to receive multiple ACKs in a queue, the multiple ACKs being scheduled for transmission on a communication channel (e.g., communication link 125). The UE 115 may execute ACK formatting component 130 to generate a packet using two or more ACKs of the multiple ACKs that correspond to a first flow, wherein the packet includes SNs of each of the two or more ACKs, an ACK counter value indicating a number of ACKs in the packet, and a payload corresponding to contents of one of the two or more ACKs. The UE 115 may execute ACK formatting component 130 to transmit the packet on the communication channel.

The wireless communication network 100 may include one or more base stations 105, one or more UEs 115, and a core network 127. The core network 127 may provide user authentication, access authorization, tracking, internet protocol (IP) connectivity, and other access, routing, or mobility functions. The base stations 105 may interface with the core network 127 through backhaul links 120 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 127), with one another over backhaul links 125 (e.g., X1, etc.), which may be wired or wireless communication links.

The base stations 105 may wirelessly communicate with the UEs 115 via one or more base station antennas. Each of the base stations 105 may provide communication coverage for a respective geographic coverage area 122. In some examples, base stations 105 may be referred to as a base transceiver station, a radio base station, an access point, an access node, a radio transceiver, a NodeB, eNodeB (eNB), gNodeB (gNB), Home NodeB, a Home eNodeB, a relay, or some other suitable terminology. The geographic coverage area 122 for a base station 105 may be divided into sectors or cells making up only a portion of the coverage area (not shown). The wireless communication network 100 may include base stations 105 of different types (e.g., macro base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 122 for different communication technologies.

In some examples, the wireless communication network 100 may be or include one or any combination of communication technologies, including a new radio (NR) or 5G technology, a Long Term Evolution (LTE) or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe the UEs 115. The wireless communication network 100 may be a heterogeneous technology network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may generally cover a relatively large geographic area (e.g., several kilometers in radius) and may allow unrestricted access by the UEs 115 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by the UEs 115 with service subscriptions with the network provider. A femto cell may also cover a small geographic area (e.g., a home) and may provide restricted access and/or unrestricted access by the UEs 115 having an association with the femto cell (e.g., in the restricted access case, the UEs 115 in a closed subscriber group (CSG) of the base station 105, which may include the UEs 115 for users in the home, and the like). A micro cell may cover a geographic area larger than a pico cell and a femto cell, but smaller than a macro cell. An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARQ) to provide retransmission at the MAC layer to improve link efficiency. In the control plane, the RRC protocol layer may provide establishment, configuration, and maintenance of an RRC connection between a UE 115 and the base station 105. The RRC protocol layer may also be used for core network 127 support of radio bearers for the user plane data. At the physical (PHY) layer, the transport channels may be mapped to physical channels.

The UEs 115 may be dispersed throughout the wireless communication network 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Additionally, a UE 115 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. A UE 115 may be able to communicate with various types of base stations 105 and network equipment including macro eNBs, small cell eNBs, macro gNBs, small cell gNBs, relay base stations, and the like.

UE 115 may be configured to establish one or more wireless communication links 125 with one or more base stations 105. The wireless communication links 125 shown in wireless communication network 100 may carry uplink (UL) transmissions from a UE 115 to a base station 105, or downlink (DL) transmissions, from a base station 105 to a UE 115. The downlink transmissions may also be called forward link transmissions while the uplink transmissions may also be called reverse link transmissions. Each wireless communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2). Moreover, in some aspects, the wireless communication links 125 may represent one or more broadcast channels.

In some aspects of the wireless communication network 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple input multiple output (MIMO) techniques that may take advantage of multi-path environments to transmit multiple spatial layers carrying the same or different coded data.

Wireless communication network 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers. The base stations 105 and UEs 115 may use spectrum up to Y MHz (e.g., Y=5, 10, 15, or 20 MHz) bandwidth per carrier allocated in a carrier aggregation of up to a total of Yx MHz (x=number of component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications network 100 may further include base stations 105 operating according to Wi-Fi technology, e.g., Wi-Fi access points, in communication with UEs 115 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

Additionally, one or more of base stations 105 and/or UEs 115 may operate according to a NR or 5G technology referred to as millimeter wave (mmW or mmwave or MMW) technology. For example, mmW technology includes transmissions in mmW frequencies and/or near mmW frequencies. Extremely high frequency (EHF) is part of the radio frequency (RF) in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. For example, the super high frequency (SHF) band extends between 3 GHz and 30 GHz, and may also be referred to as centimeter wave. Communications using the mmW and/or near mmW radio frequency band has extremely high path loss and a short range. As such, base stations 105 and/or UEs 115 operating according to the mmW technology may utilize beamforming in their transmissions to compensate for the extremely high path loss and short range.

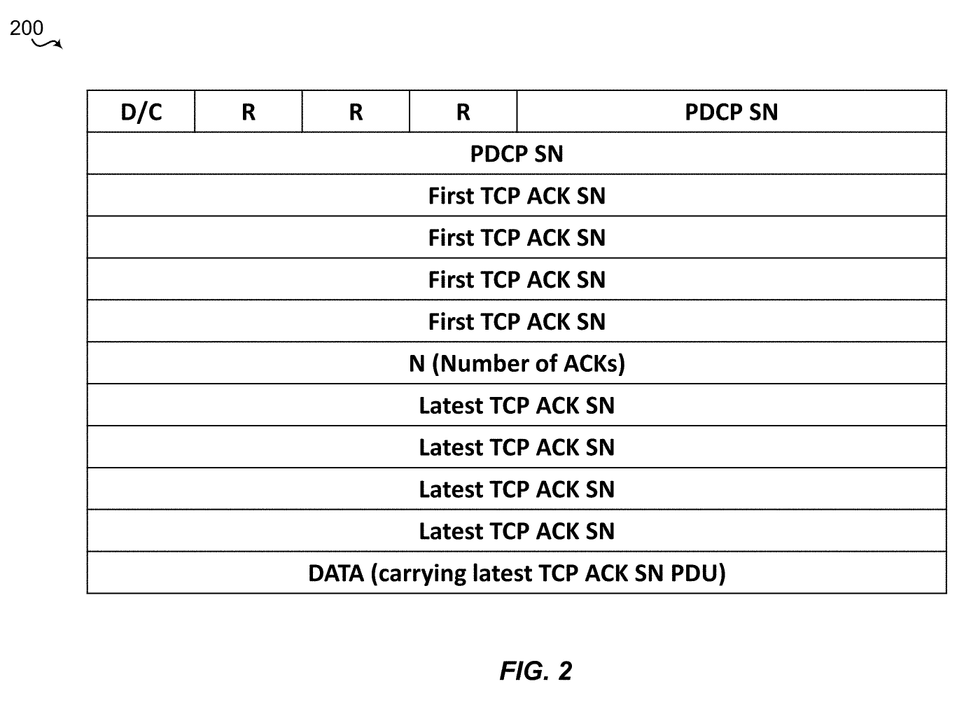

FIG. 2 illustrates a conceptual diagram of a packet 200 including SNs of each of the two or more ACKs, an ACK counter value, and a payload, the packet 200 being communicated between a transmitter and a receiver during wireless communications. In particular, the packet 200 may correspond to a PDCP Data PDU. In an example, the packet 200 may correspond to a PDCP Data PDU with a PDU type of TCP ACK and encode information for a number of TCP ACKs (e.g., N), ranging from a first TCP ACK SN to a latest TCP ACK SN. Moreover, the packet 200 may indicate in the beginning of the packet whether it is a data or control type packet. In this example, packet 200 is a data type packet. Further, after a number of reserve bits, packet 200 may include the PDCP SN. Packet 200 may information regarding the first TCP ACK SN, a ACK counter value indicating a number of ACKs in the packet 200, a latest TCP ACK SN, and a payload carrying the contents of the latest TCP ACK. For example, the first TCP ACK SN and the latest TCP ACK SN may be indicated across four (4) bytes of the packet 200 either in a large are small endian format. Additional TCP ACK dynamic information, such as TCP options field, the Timestamps field, the receiver window size, window scaling, may be included. The TCP/IP checksum field may be included as well to avoid recomputation at the receiver. The IP header of the first packet may be included, while the IP headers of the subsequent ACKs may be omitted in case it is the same, or only differences in IP header field may be included. One IP header may be included and one of more TCP connections may refer to this IP header template for decompression of the TCP/IP ACK.. As such, packet 200 may be generated by a transmitter (e.g., ACK formatting component 130/140 of FIG. 1), communicated on a communication channel as a data type PDU, and received by a receiver which can in turn use it to generate multiple TCP ACKs thereby limiting the need to unnecessarily send multiple TCP ACKs on the communication channel.

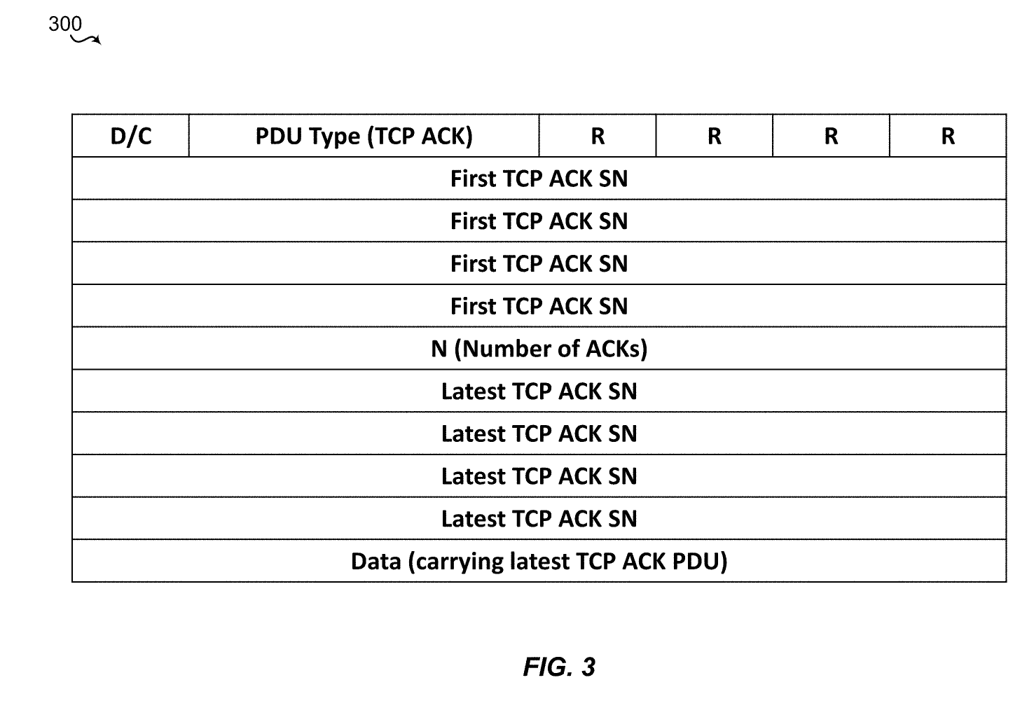

FIG. 3 illustrates a conceptual diagram of a packet 300 including SNs of each of the two or more ACKs, an ACK counter value, and a payload, the packet 300 being communicated between a transmitter and a receiver during wireless communications. In particular, the packet 300 may correspond to a PDCP Control PDU. In an example, the packet 300 may correspond to a PDCP Control PDU with a PDU type of TCP ACK and encode information for a number of TCP ACKs (e.g., N), ranging from a first TCP ACK SN to a latest TCP ACK SN. Moreover, the packet 300 may indicate in the beginning of the packet whether it is a data or control type packet. In this example, packet 300 is a control type packet. Before a number of reserve bits, packet 300 may include the PDU type. As noted, packet 300 is a TCP ACK. Packet 300 may information regarding the first TCP ACK SN, a ACK counter value indicating a number of ACKs in the packet 300, a latest TCP ACK SN, and a payload carrying the contents of the latest TCP ACK. For example, the first TCP ACK SN and the latest TCP ACK SN may be indicated across four (4) bytes of the packet 300 either in a large are small endian format. As such, packet 300 may be generated by a transmitter (e.g., ACK formatting component 130/140 of FIG. 1), communicated on a communication channel as a control type PDU, and received by a receiver which can in turn use it to generate multiple TCP ACKs thereby limiting the need to unnecessarily send multiple TCP ACKs on the communication channel.

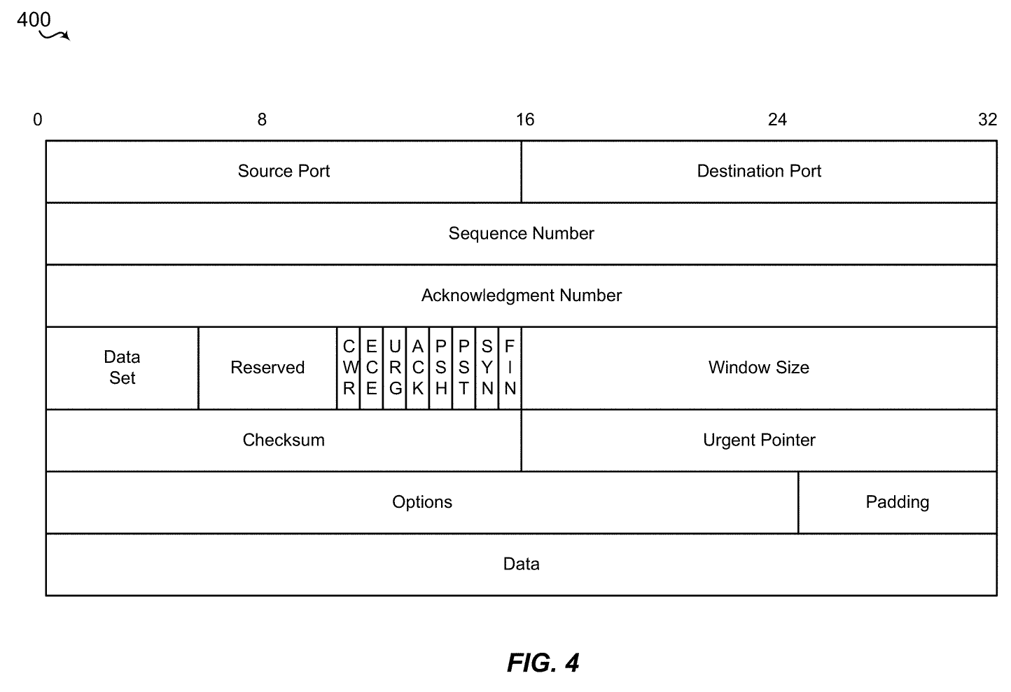

Referring to FIG. 4, a conceptual diagram of a header 400 of a packet is illustrated, the packet being communicated between a transmitter and a receiver during wireless communications. For example, each of the ACKs may comprise of a static portion that is invariable for a given connection (e.g., TCP connection) and a dynamic portion that carries data specific to the ACK. In particular, the static portion may include the IP header, the source and port numbers while the dynamic portion may include the data sequence number, ACK sequence number, size of the header (e.g., TCP header), a number of control flags (e.g., 9), receiver window size, checksum, and an options field. In an example, the options field may have a variable size and include zero or more options elements encoded as an element (e.g., option-kind, option-length, option-data). In an instance, the options field may include window scaling, timestamps (e.g., exchanged by the transmitter and receiver, and requires round-trip-time estimation), and selective ACK.

In an example, a first ACK payload template is transmitted which includes the static and dynamic portions. For subsequent ACKs, only the relevant differences (e.g., the elements inside the dynamic portion) are compared to the payload template. When no difference is indicated, the receiver re-creates (e.g., decompresses) ACKs with fields identical to the payload template. In some examples, the payload template may be transmitted less often than once per TTI. A payload template ID may be used to link a payload template with the relevant differences being signaled in future TTIs (i.e., stateful compression).

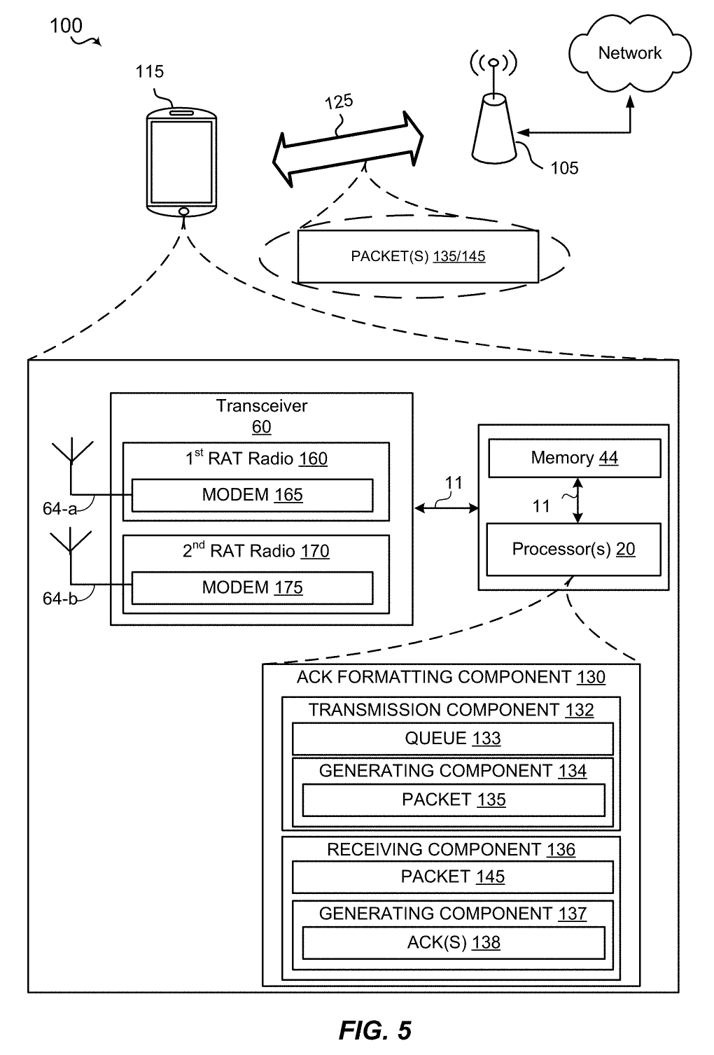

Furthermore, in order to minimize the risk of interfering with TCP operation, the ACK SN may be provided as is, or by signaling the difference compared to the template. Transmitting the difference requires much less than the bytes (e.g., 4 bytes) used to encode the ACK SN. Fewer bytes (e.g., 2 bytes) may be sufficient for packets as large as 16 KB. Additionally, while it is uncommon for the size of the header (e.g., TCP header) varies during a connection, but when a change occurs it is critical to signal the new size together with the options field responsible for the growth in header compared with payload template. The receiver may recompute this field according the packet being reconstructed. Further, assuming only TCP ACKs are being compressed, the control flags are not likely to be relevant. Moreover, the receiver window size is potentially critical. Not updating the window size means the transmitter could overflow the receiver buffer, or under-utilize the communication link. In a further example, the checksum could be signaled or could be recomputed. With regard to the options field, if the windows scaling changes then it needs to be signaled. The timestamps need to be included if the payload template is not transmitted on a regular basis. If a payload template is sent every TTI, the error occurred by using the payload template's timestamps may be acceptable. Moreover, the selective ACK may be included. Referring to FIG. 5, in a further aspect, the ACK formatting component 130 includes a receiving component 136 having generating component 137 that may generate the number of ACKs 138 corresponding to the first flow based on at least one of the power limitation condition or the grant limitation condition.

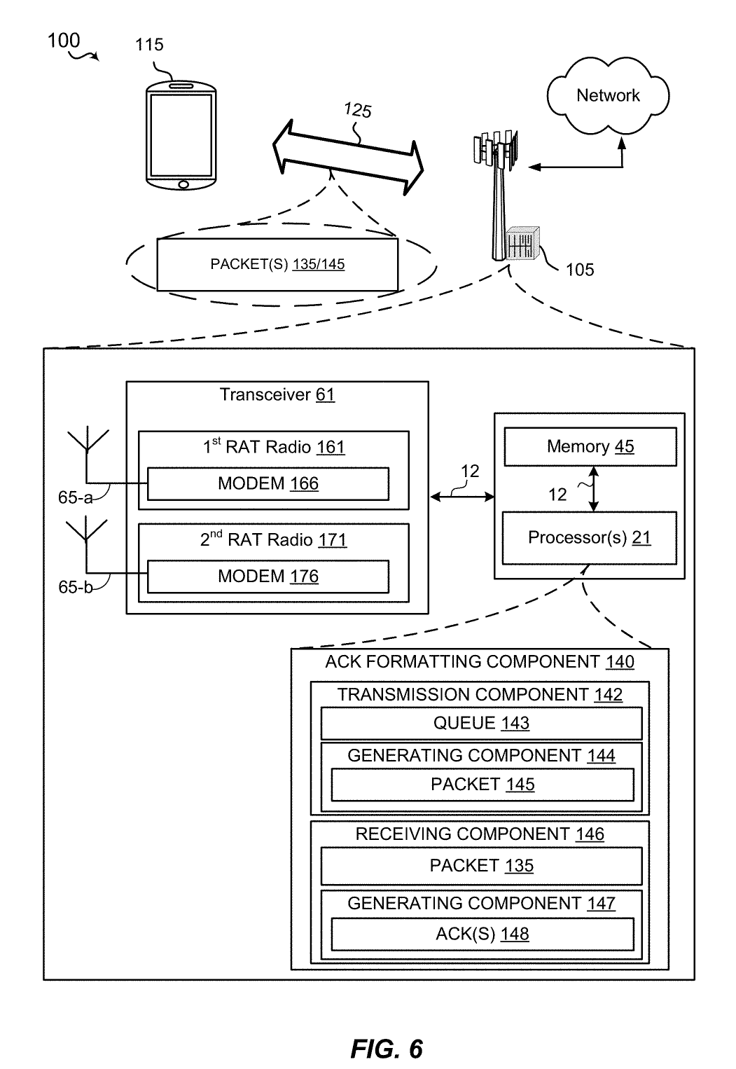

Referring to FIG. 5 and FIG. 6, in an aspect, a wireless communication system 100 includes at least one user equipment (UE) 115 in communication coverage of at least network entities 105. The UE 115 may communicate with network via network entity 105. In an example, UE 115 may transmit and/or receive wireless communication to and/or from network entity 105 via one or more communication channels 125, which may include an uplink communication channel (or simply uplink channel bandwidth region) and a downlink communication channel (or simply downlink channel bandwidth region), such as but not limited to an uplink data channel and/or downlink data channel, a control channel. Such wireless communications may include, but are not limited to, data, audio and/or video information. Moreover, in an example, the wireless communications between UE 115 and network entity 105 may include 5G NR communications.

Referring to FIG. 5, in accordance with the present disclosure, UE 115 may include a memory 44, one or more processors 20 and a transceiver 60. The memory, one or more processors 20 and the transceiver 60 may communicate internally via a bus 11. In some examples, the memory 44 and the one or more processors 20 may be part of the same hardware component (e.g., may be part of a same board, module, or integrated circuit). Alternatively, the memory 44 and the one or more processors 20 may be separate components that may act in conjunction with one another. In some aspects, the bus 11 may be a communication system that transfers data between multiple components and subcomponents of the UE 115. In some examples, the one or more processors 20 may include any one or combination of modem processor, baseband processor, digital signal processor and/or transmit processor. Additionally or alternatively, the one or more processors 20 may include an ACK formatting component 130 for carrying out one or more methods or procedures described herein. In an aspect, the term “component” as used herein may be one of the parts that make up a system, may be hardware, firmware, and/or software, and may be divided into other components. The ACK formatting component 130, and each of its subcomponents, may comprise hardware, firmware, and/or software and may be configured to execute code or perform instructions stored in a memory (e.g., a computer-readable storage medium).

In some examples, the UE 115 may include the memory 44, such as for storing data used herein and/or local versions of applications or communication with ACK formatting component 130 and/or one or more of its subcomponents being executed by the one or more processors 20. Memory 44 can include any type of computer-readable medium usable by a computer or processor 20, such as random access memory (RAM), read only memory (ROM), tapes, magnetic discs, optical discs, volatile memory, non-volatile memory, and any combination thereof. In an aspect, for example, memory 44 may be a computer-readable storage medium (e.g., a non-transitory medium) that stores one or more computer-executable codes defining ACK formatting component 130 and/or one or more of its subcomponents, and/or data associated therewith, when UE 115 is operating processor 20 to execute ACK formatting component 130 and/or one or more of its subcomponents. In some examples, the UE 115 may further include a transceiver 60 for transmitting and/or receiving one or more data and control signals to/from the network via network entity 105. The transceiver 60 may comprise hardware, firmware, and/or software and may be configured to execute code or perform instructions stored in a memory (e.g., a computer-readable storage medium). The transceiver 60 may include a 1^{st} radio access technology (RAT) radio 160 (e.g. UMTS/WCDMA, LTE-A, WLAN, Bluetooth, WSAN-FA) comprising a modem 165, and a 2^{nd} RAT radio 170 (e.g., 5G) comprising a modem 175. The 1^{st} RAT radio 160 and 2^{nd} RAT radio 170 may utilize one or more antennas 64 for transmitting signals to and receiving signals from the network entity 105. In some examples, the transceiver 60 may only include the 2^{nd} RAT radio 170.

In a blended radio environment such as system 100, different RATs may make use of different channels at different times. Because different RATs are sharing the spectrum and operating partly independently of others, access to one channel may not imply access to another channel. Accordingly, a device capable of transmitting using multiple channels may need to determine whether each channel is available before transmitting. In order to increase bandwidth and throughput, it may be beneficial in some situations to wait for an additional channel to become available rather than transmitting using currently available channel(s).

Similarly, with regard to FIG. 6, network entity 105 may include a memory 45, one or more processors 21 and a transceiver 61. Memory 45, one or more processors 21 and a transceiver 61 may operate in the same and/or similar manner to memory 44, one or more processors 20 and a transceiver 60 of UE 115 described in FIG. 5. Additionally or alternatively, the one or more processors 21 may include an ACK formatting component 140 for carrying out one or more methods or procedures described herein. Furthermore, memory 45, one or more processors 21 and a transceiver 61 may operate the same and/or similar components including, but not limited to a 1^{st} RAT radio 161 with modem 166, a 2^{nd} RAT radio 171 with modem 176, and antennas 65. Moreover, memory 45, one or more processors 21 and the transceiver 61 may communicate internally via a bus 12. In some examples, the transceiver 61 may only include the 2^{nd} RAT radio 171.

In some examples, the ACK formatting components 130/140 may be configured to encode and decode multiple ACKs for a communication channel 125 during wireless communications. In an aspect, for example, UE 115 may perform a random access procedure to connect with the network entity 105. Once UE 115 has connected with network entity 105 and has access to the network, UE 115 may communicate with network entity 105 via, at least, an uplink channel bandwidth region, downlink channel bandwidth region, and control channel bandwidth region of the communication channel 125 on a RAT (e.g., 5G). However, in order to reduce latency and increase the throughput, multiple ACKs may be encoded into a single PDU and communicated across communication channel 125.

Referring back to FIG. 5, in an aspect, UE 115 and/or ACK formatting component 130 may include a transmission component 132, which may be configured to receive multiple ACKs in a queue 133, the multiple ACKs being scheduled for transmission on a communication channel 125. In an example, the ACKs are Transmission Control Protocol (TCP) ACKs. In another example, the multiple ACKs may corresponds to a variety of flows (e.g., TCP flows). In an instance, queue 133 may also include PDUs scheduled for transmission on communication channel 125 along with the multiple ACKs.

In some aspects, UE 115 and/or ACK formatting component 130 may determine whether to encode the multiple ACKs in the queue 133 into a packet 135 based on at least one of a power limitation condition or a grant limitation condition. For example, UE 115 may receive grant information from network entity 105 which in turn may limit the transmission grant of UE 115. Further, UE 115 may be limited with regard to the transmit power for transmitting signals to network entity 105. As such, the power limitation condition or the grant limitation condition may correspond to a determination regarding whether respective thresholds for each conditions has been met.

In a further aspect, UE 115 and/or ACK formatting component 130 may determine whether a flow for successive ACKs of the multiple ACKs in the queue 133 changes from the first flow to a second flow or a total number of ACKs in the queue 133 exceeds an ACK threshold, the ACK threshold corresponding to the ACK counter value.

In a further aspect, UE 115 and/or ACK formatting component 130 may rearrange the multiple ACKs in the queue 133 based on a flow of each of the multiple ACKs and the SN of each of the multiple ACKs. Further, UE 115 and/or ACK formatting component 122 may determine whether a total number of ACKs in the queue 133 exceeds an ACK threshold, the ACK threshold corresponding to the ACK counter value.

In an aspect, ACK formatting component 130 and/or transmission component 132 may include generating component 134, which may be configured to generate a packet 135 using two or more ACKs of the multiple ACKs that correspond to a first flow. The packet 135 includes Sequence Numbers (SNs) of each of the two or more ACKs, an ACK counter value indicating a number of ACKs in the packet, and a payload corresponding to contents of one of the two or more ACKs. In an example, the packet 135 includes a packet format of a first SN, the ACK counter value, a latest SN, and a payload of an ACK correspond to the latest SN. In another example, the packet 135 is a PDU, the first flow is a first TCP flow, and the SNs are TCP ACK SNs. Moreover, in an example, the packet 135 corresponds to a Packet Data Convergence Protocol (PDCP) PDU, which may correspond to either a PDCP Data PDU or a PDCP Control PDU.

In a further aspect, generating component 134 may generate the packet 135 using the two or more ACKs of the multiple ACKs that correspond to the first flow in response to a determination that the flow for the successive ACKs of the multiple ACKs in the queue 133 changes from the first flow to the second flow or the total number of ACKs in the queue 133 exceeds the ACK threshold.

In a further aspect, generating component 134 may generate the packet 135 using the two or more ACKs of the multiple ACKs that correspond to the first flow in response to rearranging the multiple ACKs in the queue 133 and a determination that total number of ACKs in the queue 133 exceeds the ACK threshold.

In a further aspect, generating component 134 may generate the packet 135 using the two or more ACKs of the multiple ACKs that correspond to the first flow based on at least one of the power limitation condition or the grant limitation condition.

In an aspect, UE 115 and/or ACK formatting component 130 may include receiving component 136, which may be configured to receive a packet 145 on a communication channel 125. For example, the packet 145 may include SNs of each of two or more ACKs that correspond to a first flow, an ACK counter value indicating a number of ACKs in the packet 145, and a payload corresponding to contents of one of the two or more ACKs. Further, the two or more ACKs each correspond to two or more packets previously transmitted on the communication channel 125.

In a further aspect, UE 115 and/or ACK formatting component 130 may determine whether to decode the number of ACKs 138 from the packet 145 based on at least one of a power limitation condition or a grant limitation condition.

In an aspect, UE 115 and/or ACK formatting component 130 may include generating component 137, which may be configured to generate a number of ACKs 138 corresponding to the first flow using the SNs of each of the two or more ACKs, the ACK counter value, and the payload based on the packet 145. In an example, the number of ACKs corresponds to the ACK counter value. In a further example, the packet includes a packet format of a first SN, the ACK counter value, a latest SN, and a payload of a ACK correspond to the latest SN. In another example, the packet 145 is a PDU, the first flow is a first TCP flow, and the SNs are TCP ACK SNs. Moreover, in an example, the packet 145 corresponds to a PDCP PDU, which may correspond to either a PDCP Data PDU or a PDCP Control PDU.

In an aspect, for example, generating component 137 may be configured to generate a payload template using the payload included in the packet 145, wherein a packet is reconstructed based on the payload template, generate a number of copies of the payload template for each of the number of ACKs 138, the number of copies corresponding to the ACK counter value, insert a SN into each of the copies of the payload template, the SN corresponding to the SNs of each of the two or more ACKs, and compute a checksum for each of the copies of the payload template based on the SN of each of the copies of the payload template.

Referring to FIG. 2, in an aspect, network entity 105 may include an ACK formatting component 140 for carrying out one or more methods or procedures described above with regards to ACK formatting component 130. As such, in an example, ACK formatting component 140 may operate as either a transmitter and encode multiple ACKs for transmission as packet 145 or a receiver and receive packet 135 and decode multiple ACKs from it.

A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNodeBs, small cell eNodeBs, relays, and the like. A UE 115 may also be able to communicate over different access networks, such as cellular or other WWAN access networks, or WLAN access networks.

Additionally, as used herein, the one or more wireless nodes, including, but not limited to, network entity 105 of wireless communication system 100, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 100 may include one or more small cell base stations, such as, but not limited to a femtocell, picocell, microcell, or any other base station having a relatively small transmit power or relatively small coverage area as compared to a macro base station.

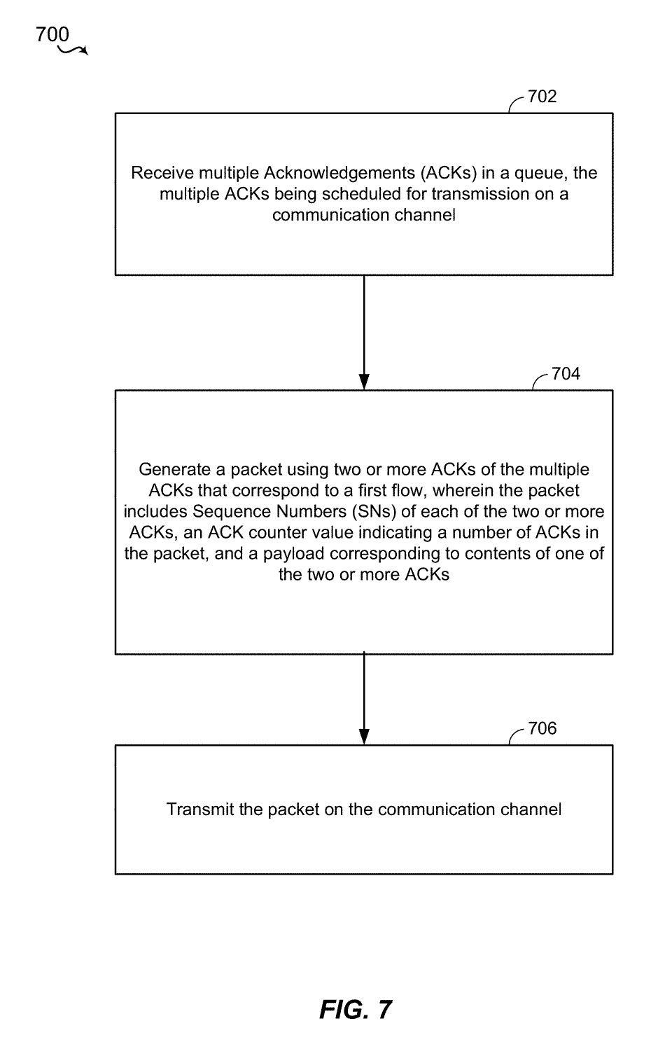

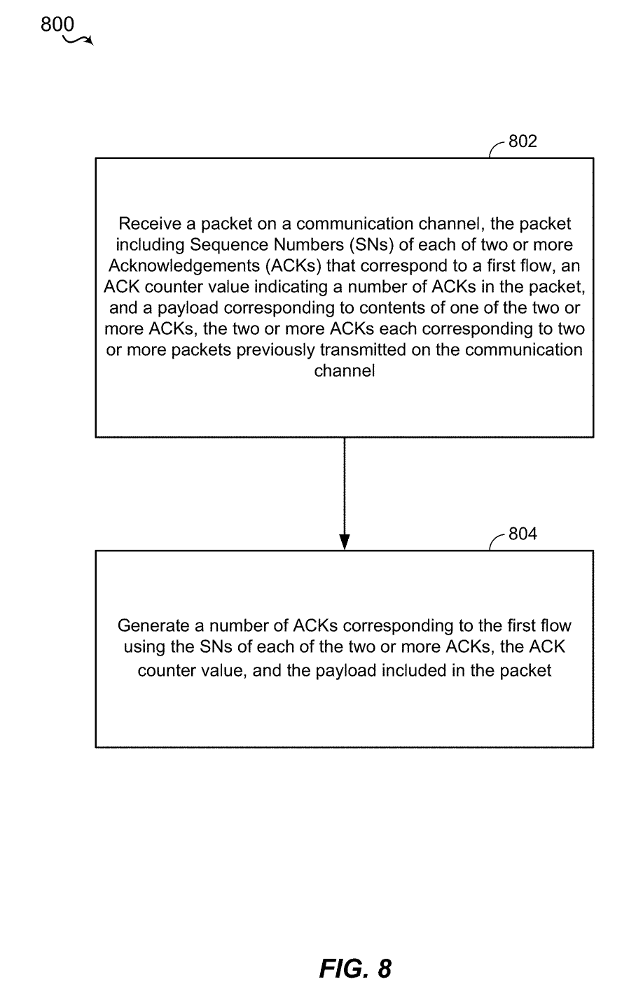

FIG. 7 and FIG. 8 are flow diagrams illustrating examples of methods related to encoding and decoding multiple ACKs with various aspects of the present disclosure. Although the operations described below are presented in a particular order and/or as being performed by an example component, it should be understood that the ordering of the actions and the components performing the actions may be varied, depending on the implementation. Also, although the ACK formatting components 130 and 140 are illustrated as having a number of subcomponents, it should be understood that one or more of the illustrated subcomponents may be separate from, but in communication with, the ACK formatting components 130 and 140, and/or each other. Moreover, it should be understood that any of actions or components described below with respect to the ACK formatting components 130 and 140 and/or their subcomponents may be performed by a specially-programmed processor, a processor executing specially-programmed software or computer-readable media, or by any other combination of a hardware component and/or a software component specially configured for performing the described actions or components.

Referring to FIG. 7, in an aspect, at block 702, method 700 includes receiving multiple ACKs in a queue, the multiple ACKs being scheduled for transmission on a communication channel. In an aspect, for example, UE 115 ACK formatting component 130 (FIG. 5) and transmission component 132 to receive multiple ACKs in a queue 133, the multiple ACKs being scheduled for transmission on a communication channel 125. In an example, the ACKs are TCP ACKs.

In an aspect, at block 704, method 700 includes generating a packet using two or more ACKs of the multiple ACKs that correspond to a first flow, wherein the packet includes SNs of each of the two or more ACKs, an ACK counter value indicating a number of ACKs in the packet, and a payload corresponding to contents of one or more of the two or more ACKs. In an aspect, for example, UE 115 and/or ACK formatting component 130 (FIG. 5) may execute generating component 134 to generate a packet 135 using two or more ACKs of the multiple ACKs that correspond to a first flow, wherein the packet includes SNs of each of the two or more ACKs, an ACK counter value indicating a number of ACKs in the packet 135, and a payload corresponding to contents of one or more of the two or more ACKs. In an example, the packet 135 includes a packet format of a first SN, the ACK counter value, a latest SN, and a payload of an ACK corresponding to the latest SN. In a further example, the packet 135 is a PDU, the first flow is a first TCP flow, and the SNs are TCP ACK SNs. In a further example, the packet 135 corresponds to a PDCP PDU, which may be either a PDCP Data PDU or a PDCP Control PDU.

In an aspect, method 700 may further include determining whether a flow for successive ACKs of the multiple ACKs in the queue 133 changes from the first flow to a second flow or a total number of ACKs in the queue 133 exceeds an ACK threshold, the ACK threshold corresponding to the ACK counter value. In one example, the ACK threshold is a maximum allowed number of bits, N. The PDCP transmitting entity may count the successive TCP ACKs which belong to the same flow and encode them into one PDCP packet as long as the total number of ACKs are less than N bits. The PDCP entity will encode a new PDCP packet every time a new flow is identified in the list of TCP ACKs, or more ACKs are identified than can be identified by N. The PDCP packet comprises the first TCP ACK SN, the maximum number of bits N, and the latest or most recent TCP ACK SN. As such, generating the packet 135 using the two or more ACKs of the multiple ACKs that correspond to the first flow further comprises generating a new packet 135 using the two or more ACKs of the multiple ACKs that correspond to a second flow in response to a determination that the flow for the successive ACKs of the multiple ACKs in the queue 133 changes from the first flow to the second flow or the total number of ACKs in the queue 133 exceeds the ACK threshold. For example, from the head of the queue, if there are 7 TCP ACKs, [flow 1, TCP ACK SN 10], [flow 1, TCP ACK SN 12], [flow 1, TCP ACK SN 14], [flow 2, TCP ACK SN 25], [flow 2, TCP ACK SN 27], [flow 1, TCP ACK SN 16], [flow 1, TCP ACK SN 18], the TCP ACKs can be encoded as:
PDU 1 carrying [first TCP ACK SN 10, N=3, Latest TCP ACK SN 14, Data part of PDU carrying Latest TCP ACK Packet]
PDU 2 carrying [first TCP ACK SN 25, N=2, Latest TCP ACK SN 27, Data part of PDU carrying Latest TCP ACK Packet]
PDU 3 carrying [first TCP ACK SN 16, N=2, Latest TCP ACK SN 18, Data part of PDU carrying Latest TCP ACK Packet]

On the receiver end, the PDCP receiving entity will generate N number of TCP ACKs starting from first TCP ACK SN to the most recent or latest TCP ACK SN. The latest TCP ACK SN will help TCP Stack to move the Sliding window protocol while multiple TCP ACKs will help the TCP window management to scale up, very similar to a LAN environment.

In another aspect, method 700 may further include rearranging the multiple ACKs in the queue 133 based on a flow of each of the multiple ACKs and the SN of each of the multiple ACKs, and determining whether a total number of ACKs in the queue 133 exceeds an ACK threshold, the ACK threshold corresponding to the ACK counter value. As such, generating the packet 135 using the two or more ACKs of the multiple ACKs that correspond to the first flow further comprises generating the packet 135 using the two or more ACKs of the multiple ACKs that correspond to the first flow in response to rearranging the multiple ACKs in the queue 133 and a determination that total number of ACKs in the queue 133 exceeds the ACK threshold.

In another aspect, method 700 may further include determining whether to encode the multiple ACKs in the queue into the packet 135 based on at least one of a power limitation condition or a grant limitation condition. As such, generating the packet 135 using the two or more ACKs of the multiple ACKs that correspond to the first flow further comprises generating the packet 135 using the two or more ACKs of the multiple ACKs that correspond to the first flow based on at least one of the power limitation condition or the grant limitation condition.

In an aspect, at block 706, method 700 includes transmitting the packet on the communication channel. In an aspect, for example, UE 115 and/or ACK formatting component 130 (FIG. 5) may execute transmission component 132 and/or transceiver 60 (and more specifically 2^{nd} RAT radio 170 (e.g., 5G)) to transmit the packet 135 on the communication channel 125.

Referring to FIG. 8, in an aspect, at block 802, method 800 includes receiving a packet on a communication channel, the packet including SNs of each of two or more ACKs that correspond to a first flow, an ACK counter value indicating a number of ACKs in the packet, and a payload corresponding to contents of one of the two or more ACKs, the two or more ACKs each corresponding to two or more packets previously transmitted on the communication channel. In an aspect, for example, network entity 105 may execute ACK formatting component 140 (FIG. 6) and/or receiving component 146 to receive a packet 135 on a communication channel 125, the packet 135 including SNs of each of two or more ACKs that correspond to a first flow, an ACK counter value indicating a number of ACKs in the packet 135, and a payload corresponding to contents of one of the two or more ACKs, the two or more ACKs each corresponding to two or more packets previously transmitted on the communication channel 125. In an example, the packet 135 includes a packet format of a first SN, the ACK counter value, a latest SN, and a payload of a ACK correspond to the latest SN. In another example, the ACKs are TCP ACKs, the packet is a PDU, the first flow is a first TCP flow, and the SNs are TCP ACK SNs. In a further example, the packet 135 corresponds to a PDCP PDU, which may be either a PDCP Data PDU or a PDCP Control PDU.

In an aspect, at block 804, method 800 includes generating a number of ACKs corresponding to the first flow based on the packet using the SNs of each of the two or more ACKs, the ACK counter value, and the payload. In an aspect, for example, network entity 105 and/or ACK formatting component 140 (FIG. 6) may execute generating component 147 to generate a number of ACKs 148 corresponding to the first flow based on the packet 135 using the SNs of each of the two or more ACKs, the ACK counter value, and the payload. In an example, the number of ACKs 148 corresponds to the ACK counter value.

In an aspect, generating the number of ACKs 148 further comprises generating a payload template using the payload included in the packet 135, wherein a packet is reconstructed based on the payload template, generating a number of copies of the payload template for each of the number of ACKs 148, the number of copies corresponding to the ACK counter value, inserting a SN into each of the copies of the payload template, the SN corresponding to the SNs of each of the two or more ACKs, and computing a checksum for each of the copies of the payload template based on the SN of each of the copies of the payload template.

In another aspect, method 800 may further include determining whether to decode the number of ACKs 148 from the packet 135 based on at least one of a power limitation condition or a grant limitation condition. As such, generating the number of ACKs 148 corresponding to the first flow further comprises generating the number of ACKs 148 corresponding to the first flow based on at least one of the power limitation condition or the grant limitation condition.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of wireless communication, comprising:
receiving multiple Acknowledgements (ACKs) in a queue, the multiple ACKs being scheduled for transmission on a communication channel;
generating a packet using two or more ACKs of the multiple ACKs that correspond to a first flow, wherein the packet includes Sequence Numbers (SNs) of each of the two or more ACKs, and a payload corresponding to contents of one of the two or more ACKs; and
transmitting the packet on the communication channel.

2. The method of claim 1, wherein the packet includes an ACK counter value indicating a number of ACKs in the packet.

3. The method of claim 2, further comprising:
determining whether a flow for successive ACKs of the multiple ACKs in the queue changes from the first flow to a second flow or a total number of ACKs in the queue exceeds an ACK threshold, the ACK threshold corresponding to the ACK counter value; and
wherein generating the packet using the two or more ACKs of the multiple ACKs that correspond to the first flow further comprises generating the packet using the two or more ACKs of the multiple ACKs that correspond to the first flow in response to a determination that the flow for the successive ACKs of the multiple ACKs in the queue changes from the first flow to the second flow or the total number of ACKs in the queue exceeds the ACK threshold.

4. The method of claim 2, further comprising:
rearranging the multiple ACKs in the queue based on a flow of each of the multiple ACKs and the SN of each of the multiple ACKs;
determining whether a total number of ACKs in the queue exceeds an ACK threshold, the ACK threshold corresponding to the ACK counter value; and
wherein generating the packet using the two or more ACKs of the multiple ACKs that correspond to the first flow further comprises generating the packet using the two or more ACKs of the multiple ACKs that correspond to the first flow in response to rearranging the multiple ACKs in the queue and a determination that total number of ACKs in the queue exceeds the ACK threshold.

5. The method of claim 2, wherein the packet includes a packet format of a first SN, the ACK counter value, a latest SN, and a payload of a ACK correspond to the latest SN.

6. The method of claim 1, further comprising:
determining whether to encode the multiple ACKs in the queue into the packet based on at least one of a power limitation condition or a grant limitation condition; and
wherein generating the packet using the two or more ACKs of the multiple ACKs that correspond to the first flow further comprises generating the packet using the two or more ACKs of the multiple ACKs that correspond to the first flow based on at least one of the power limitation condition or the grant limitation condition.

7. The method of claim 1, wherein the ACKs are Transmission Control Protocol (TCP) ACKs, the packet is a Packet Data Unit (PDU), the first flow is a first TCP flow, and the SNs are TCP ACK SNs.

8. The method of claim 1, wherein the packet corresponds to a Packet Data Convergence Protocol (PDCP) Packet Data Unit (PDU).

9. The method of claim 8, wherein the PDCP PDU corresponds to either a PDCP Data PDU or a PDCP Control PDU.

10. A method of wireless communication, comprising:
receiving a packet on a communication channel, the packet including Sequence Numbers (SNs) of each of two or more Acknowledgements (ACKs) that correspond to a first flow, and a payload corresponding to contents of one of the two or more ACKs, the two or more ACKs each corresponding to two or more packets previously transmitted on the communication channel; and
generating a number of ACKs corresponding to the first flow using the SNs of each of the two or more ACKs, the ACK counter value, and the payload included in the packet.

11. The method of claim 10, wherein the packet includes an ACK counter value indicating a number of ACKs in the packet.

12. The method of claim 11, wherein generating the number of ACKs further comprises:
generating a payload template using the payload included in the packet, wherein a packet is reconstructed based on the payload template;
generating a number of copies of the payload template for each of the number of ACKs, the number of copies corresponding to the ACK counter value;
inserting a SN into each of the copies of the payload template, the SN corresponding to the SNs of each of the two or more ACKs; and
computing a checksum for each of the copies of the payload template based on the SN of each of the copies of the payload template.

13. The method of claim 11, wherein the number of ACKs corresponds to the ACK counter value.

14. The method of claim 11, wherein the packet includes a packet format of a first SN, the ACK counter value, a latest SN, and a payload of a ACK correspond to the latest SN.

15. The method of claim 10, further comprising:
determining whether to decode the number of ACKs from the packet based on at least one of a power limitation condition or a grant limitation condition; and
wherein generating the number of ACKs corresponding to the first flow further comprises generating the number of ACKs corresponding to the first flow based on at least one of the power limitation condition or the grant limitation condition.

16. The method of claim 10, wherein the ACKs are Transmission Control Protocol (TCP) ACKs, the packet is a Packet Data Unit (PDU), the first flow is a first TCP flow, and the SNs are TCP ACK SNs.

17. The method of claim 10, wherein the packet corresponds to a Packet Data Convergence Protocol (PDCP) Packet Data Unit (PDU).

18. The method of claim 17, wherein the PDCP PDU corresponds to either a PDCP Data PDU or a PDCP Control PDU.

19. An apparatus for wireless communications, comprising:
a transceiver;
a memory configured to store data; and
one or more processors communicatively coupled with the transceiver and the memory, the one or more processors being configured to:
receive multiple Acknowledgements (ACKs) in a queue, the multiple ACKs being scheduled for transmission on a communication channel;
generate a packet using two or more ACKs of the multiple ACKs that correspond to a first flow, wherein the packet includes Sequence Numbers (SNs) of each of the two or more ACKs, and a payload corresponding to contents of one of the two or more ACKs; and
transmit, via the transceiver, the packet on the communication channel.

20. The apparatus of claim 19, wherein the packet includes an ACK counter value indicating a number of ACKs in the packet.

21. The apparatus of claim 20, wherein the one or more processors is further configured to:
determine whether a flow for successive ACKs of the multiple ACKs in the queue changes from the first flow to a second flow or a total number of ACKs in the queue exceeds an ACK threshold, the ACK threshold corresponding to the ACK counter value; and
wherein the one or more processors configured to generate the packet using the two or more ACKs of the multiple ACKs that correspond to the first flow is further configured to generate the packet using the two or more ACKs of the multiple ACKs that correspond to the first flow in response to a determination that the flow for the successive ACKs of the multiple ACKs in the queue changes from the first flow to the second flow or the total number of ACKs in the queue exceeds the ACK threshold.

22. The apparatus of claim 20, wherein the one or more processors is further configured to:
rearrange the multiple ACKs in the queue based on a flow of each of the multiple ACKs and the SN of each of the multiple ACKs;
determine whether a total number of ACKs in the queue exceeds an ACK threshold, the ACK threshold corresponding to the ACK counter value; and
wherein the one or more processors configured to generate the packet using the two or more ACKs of the multiple ACKs that correspond to the first flow is further configured to generate the packet using the two or more ACKs of the multiple ACKs that correspond to the first flow in response to rearranging the multiple ACKs in the queue and a determination that total number of ACKs in the queue exceeds the ACK threshold.

23. The apparatus of claim 20, wherein the packet includes a packet format of a first SN, the ACK counter value, a latest SN, and a payload of a ACK correspond to the latest SN.

24. The apparatus of claim 19, wherein the one or more processors is further configured to:
determine whether to encode the multiple ACKs in the queue into the packet based on at least one of a power limitation condition or a grant limitation condition; and wherein the one or more processors configured to generate the packet using the two or more ACKs of the multiple ACKs that correspond to the first flow is further configured to generate the packet using the two or more ACKs of the multiple ACKs that correspond to the first flow based on at least one of the power limitation condition or the grant limitation condition.

25. An apparatus for wireless communications, comprising:
a transceiver;
a memory configured to store data; and
one or more processors communicatively coupled with the transceiver and the memory, the one or more processors being configured to:
receive, via the transceiver, a packet on a communication channel, the packet including Sequence Numbers (SNs) of each of two or more Acknowledgements (ACKs) that correspond to a first flow, and a payload corresponding to contents of one of the two or more ACKs, the two or more ACKs each corresponding to two or more packets previously transmitted on the communication channel; and
generate a number of ACKs corresponding to the first flow using the SNs of each of the two or more ACKs, the ACK counter value, and the payload included in the packet.

26. The apparatus of claim 25, wherein the packet includes an ACK counter value indicating a number of ACKs in the packet.

27. The apparatus of claim 26, wherein the one or more processors is further configured to:
generate a payload template using the payload included in the packet, wherein a packet is reconstructed based on the payload template;
generate a number of copies of the payload template for each of the number of ACKs, the number of copies corresponding to the ACK counter value;
insert a SN into each of the copies of the payload template, the SN corresponding to the SNs of each of the two or more ACKs; and
compute a checksum for each of the copies of the payload template based on the SN of each of the copies of the payload template.

28. The apparatus of claim 26, wherein the number of ACKs corresponds to the ACK counter value.

29. The apparatus of claim 26, wherein the packet includes a packet format of a first SN, the ACK counter value, a latest SN, and a payload of a ACK correspond to the latest SN.

30. The apparatus of claim 25, wherein the one or more processors is further configured to:
determine whether to decode the number of ACKs from the packet based on at least one of a power limitation condition or a grant limitation condition; and
wherein the one or more processors configured to generate the number of ACKs corresponding to the first flow is further configured to generating the number of ACKs corresponding to the first flow based on at least one of the power limitation condition or the grant limitation condition.
